(19) United States
(12) Patent Application Publication
(10) Pub. No.: US 2018/0204545 A1
(43) Pub. Date: Jul. 19, 2018

(54) CHROMATIC HARMONICA WITH FLEXIBLE MOUTHPIECE FOR REDUCED AIR LEAKAGE

(71) Applicant: David PEARCE, Granada Hills, CA (US)

(72) Inventor: David PEARCE, Granada Hills, CA (US)

(21) Appl. No.: 15/229,073

(22) Filed: Aug. 4, 2016

(51) Int. Cl. G10D 7/12; G10D 9/02

(52) U.S. Cl. CPC G10D 7/123; G10D 9/02

(57) ABSTRACT

A chromatic harmonica with reduced air leakage in which a flexible mouthpiece replaces the conventional rigid mouthpiece, and a low friction valve slide replaces the conventional valve slide, thereby allowing the low friction valve slide to move horizontally when played without binding, and which eliminates the need for a gap between the mouthpiece and valve slide through which air leaks. For the chromatic harmonica with a flexible mouthpiece to function properly, a new button configuration is added. The button is disposed in the rear portion of the chromatic harmonica. A bar is attached to the button at one end of the bar, and the other end of the bar inserts into an opening in the valve slide. The button further comprises a cylinder, around which a spring is disposed. The cylinder inserts inside of a hole on a side of the chromatic harmonica adjacent the rear.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND

The chromatic harmonicas is known. Typically, a chromatic harmonica comprises a comb, a valve slide, and a mouthpiece. The comb comprises comb reed chambers. The valve slide is normally metal and comprises a slide button. The mouthpiece comprises numerous mouthpiece holes, into which a player inhales and exhales to make different sounds. The mouthpiece is normally rigid metal or plastic.

To form various pitches, a player inhales or exhales in the holes of the mouthpiece and moves the valve slide to direct air between two different reed chambers per mouthpiece hole. When the valve slide is not activated, air is directed to a reed chamber containing a blow and draw reed, forming one pitch. When the player activates the valve slide by pressing the slide button, air from the mouthpiece is redirected to a different reed chamber containing different blow and draw reeds with different pitches. For example, when the slide button is not activated, a player forms a “C” note when blowing into a mouthpiece hole. When the slide button is activated, the “C” note will sharp up a half step to a “C-sharp”. When the slide button is released, a torsion or compression spring attached to the valve slide spring moves the valve slide back to its original position.

Harmonica players often cup their hands at the back of the harmonica in order to shape the tones they play. Conventional chromatic harmonica slide buttons are located at the front of the harmonica, which makes hand cupping difficult.

To keep the valve slide moving freely and to prevent the valve slide from binding, a small gap exists between the mouthpiece, valve slide, and harmonica comb. This has the unfortunate effect of allowing air to leak when playing the harmonica. This in turn affects the player's ability to vibrate and control the harmonica reeds. The reduced airflow also lowers the volume of the reeds played.

To compensate for air leaks, small flaps of material called “windsavers” (or “valves”) are attached to each reed slot on the opposite side of the location where each reed is attached to the reed plate. The windsavers shut and stop air from flowing through a draw reed when the player exhales to play a blow reed. They also stop the air from flowing back through the blow reed when the player inhales to play a draw reed. Windsavers complicate the construction and maintenance of the chromatic harmonica and prevent a player from using a desired technique known as “interactive reed bending.” This bending technique utilizes both reeds in a particular reed chamber of the harmonica to produce a musical note distinct from the blow or draw note that can be obtained from that chamber. Interactive reed bending implies producing a lowering of pitch by shaping the mouth and restricting the airflow in the oral cavity while blowing or drawing. This stimulates the reed not normally played when either blowing or drawing to produce a note higher than it would if it were being played in the normal manner, but lower than that of the higher pitched reed. A chromatic harmonica with windsavers attached to lower pitched reeds in each reed chamber prevents the lower pitched reeds from vibrating when the higher pitched reed is played and thus does not allow interactive reed bending to occur. If the windsavers on the lower pitched reeds are removed then interactive reed bending is possible, but most conventional chromatics are not airtight enough to function well without windsavers on all the reeds.

Many chromatic harmonicas with screw-on mouthpieces require the player to carefully adjust the mouthpiece screws in order to achieve maximum air tightness without binding the slide valve. Other chromatics use some means of creating a fixed gap between the mouthpiece, valve slide, and comb face and cannot be adjusted. Creating the minimum sliding tolerance gap in the mouthpiece/slide valve assembly when manufacturing a conventional chromatic harmonica is a challenging and time-consuming process. The time and labor required to manufacture and inspect parts with exceptionally exacting tolerances drives up the cost of the harmonica. As a result, manufacturers often increase the sliding tolerance gap in the mouthpiece/valve slide assembly so that the instrument can be quickly and cheaply manufactured. Increasing the sliding tolerance in the mouthpiece/slide valve has the obvious disadvantage of decreasing the air tightness of the instrument. Players often have to modify such instruments to improve the air tightness of the mouthpiece/valve slide assembly.

The objective of this invention is to improve the playability of the Chromatic Harmonica by decreasing air leaks in the mouthpiece/valve slide assembly.

### SUMMARY

The present invention comprises a Chromatic Harmonica with a flexible mouthpiece, for example, comprised of rubber, and a valve slide constructed from a low friction material such as Polyterafluoroethylene (PTFE), Polyoxymethylene (POM, also known as acetal), or PTFE-filled Acetal homopolymer. The low friction of the slide material allows the valve slide to move freely without a gap in the mouthpiece/valve slide assembly.

The inner face of the rubber-like flexible mouthpiece rests directly on the low friction valve slide and pressure from the player's mouth creates an airtight seal between the mouthpiece, valve slide, and comb face. The flexibility of the mouthpiece allows it to conform to the face of the valve slide when pressed against the comb face and eliminates the need for perfect flatness in the mouthpiece interior, slide valve and comb face. Since this design relies on mouth pressure to create the seal, the need to carefully adjust the mouthpiece screws is eliminated. Because the mouthpiece, valve slide, and comb face do not require a gap with an exact tolerance and perfect flatness, the manufacturing process would be much simpler and faster than a conventional Chromatic Harmonica. The speed and ease of the valve slide movement and air tight seal in the mouthpiece can be furthered enhanced by using a silicone based lubricant or any other lubricant that is compatible with the materials used to construct the mouthpiece, slide valve, and comb face.

Unfortunately, the conventional Chromatic Harmonica button/spring configuration cannot be used with the flexible mouthpiece because the mouthpiece is not rigid enough to prevent the spring from pushing the slide valve away from the comb face when the slide button is pushed. Other conventional Chromatic Harmonica that use compression springs also cannot be used with the flexible mouthpiece because the lack of the mouthpiece's rigidity causes instability when the button is pushed. A new slide button configuration is also necessary.

The new button configuration is disposed in the rear of the Chromatic Harmonica, and a bar connects both the button and the valve slide so that when the button is pushed, the valve slide moves horizontally along the face of the comb. The button comprises a cylinder which inserts into a hole in the rear of the Chromatic Harmonica, which, along with two columns, keeps the bar-button-valve slide connection stable. The cylinder has a compression spring wrapped around it, so that when the button is depressed, the spring pushes the button, bar, and valve slide back to their original positions. The two columns also prevent the player's lips from getting pinched by the bar when the button is pushed.

Having the button in the rear of the Chromatic Harmonica also makes it easier for a player to cup his hands at the back of the Chromatic Harmonica

The result is an improved chromatic harmonica with improved air tightness, a simpler assembly, in which all or half of the windsavers can be removed. The Chromatic Harmonica is easier and quicker to manufacture. Disassembly, cleaning, and reassembly becomes quick and easy and a player will have greater control and volume. The desired technique of interactive reed bend is available to the player allowing greater expressiveness with the instrument

### DRAWINGS

FIG. 1 is the Chromatic Harmonica with a flexible mouthpiece, a low-friction valve slide, and a button and spring configuration in the rear

FIG. 2 is a first conventional Chromatic Harmonica with a rigid mouthpiece, a valve slide, and a button and spring configuration in the front side of the harmonica.

FIG. 3 is a second conventional Chromatic Harmonica with a rigid mouthpiece, a valve slide, and a button and spring configuration in the front side of the harmonica.

FIG. 4 shows how a conventional Chromatic Harmonica is constructed.

FIG. 5 shows how the Chromatic Harmonica with flexible Mouthpiece is constructed.

### DESCRIPTION

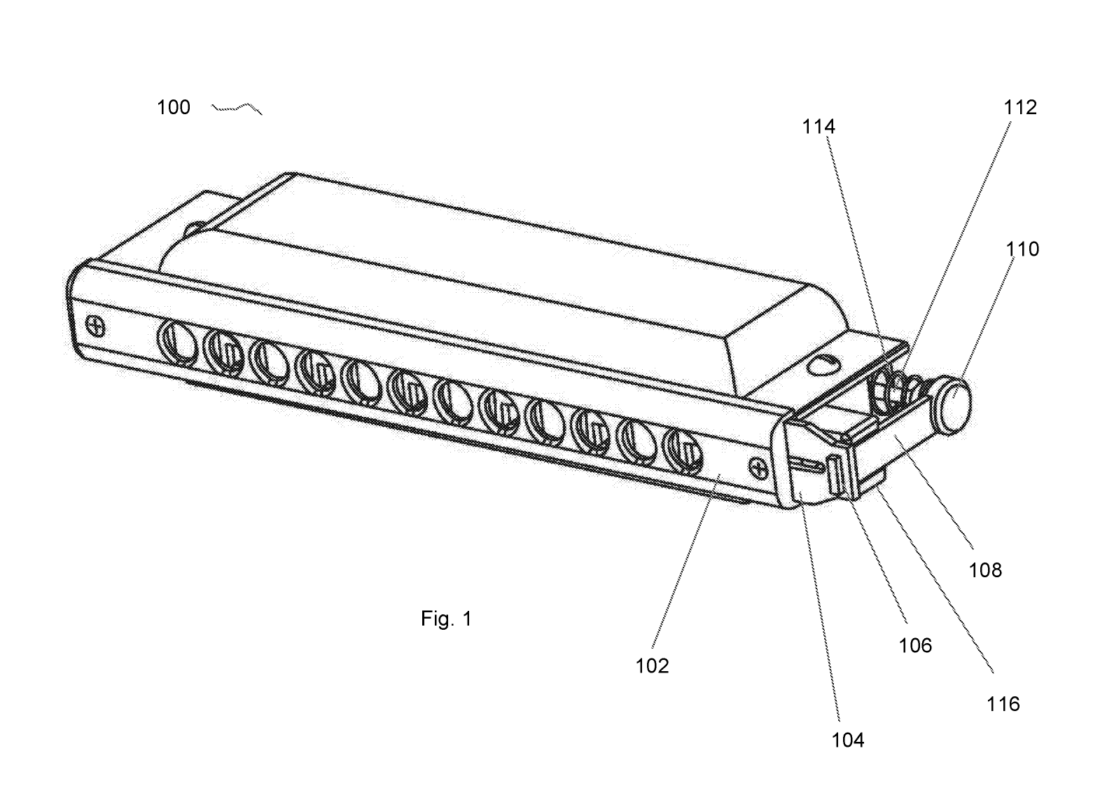

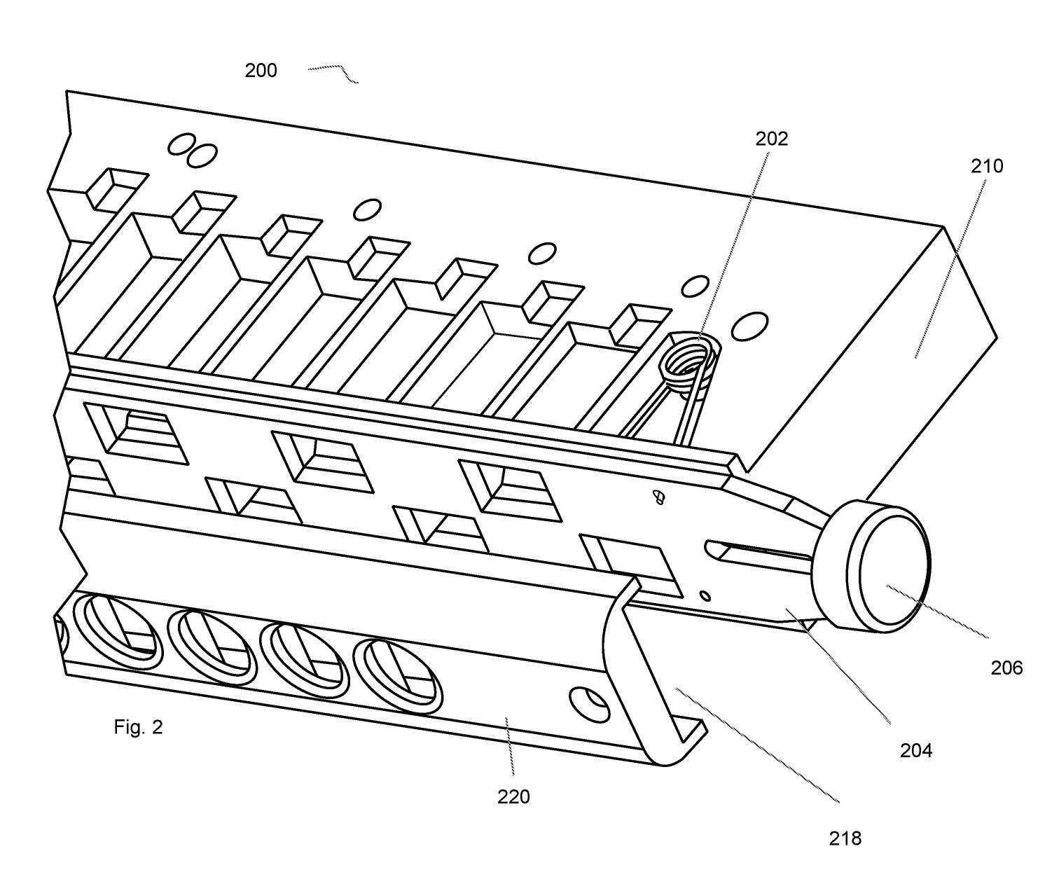

FIG. 1 illustrates the Chromatic Harmonica 100 of the present invention, which comprises a flexible mouthpiece 102 composed, for example, of rubber, and a low-friction valve slide 104. The low-friction valve slide 104 is composed of low friction material such as Polyterafluoroethylene (PTFE), Polyoxymethylene (POM), also known as acetal, or a PTFE-filled Acetal homopolymer. Such material allows the valve slide 104 to move freely without the need for a gap 218 between the mouthpiece 102 and valve slide 104 as shown in FIG. 2 for a conventional chromatic harmonica 200.

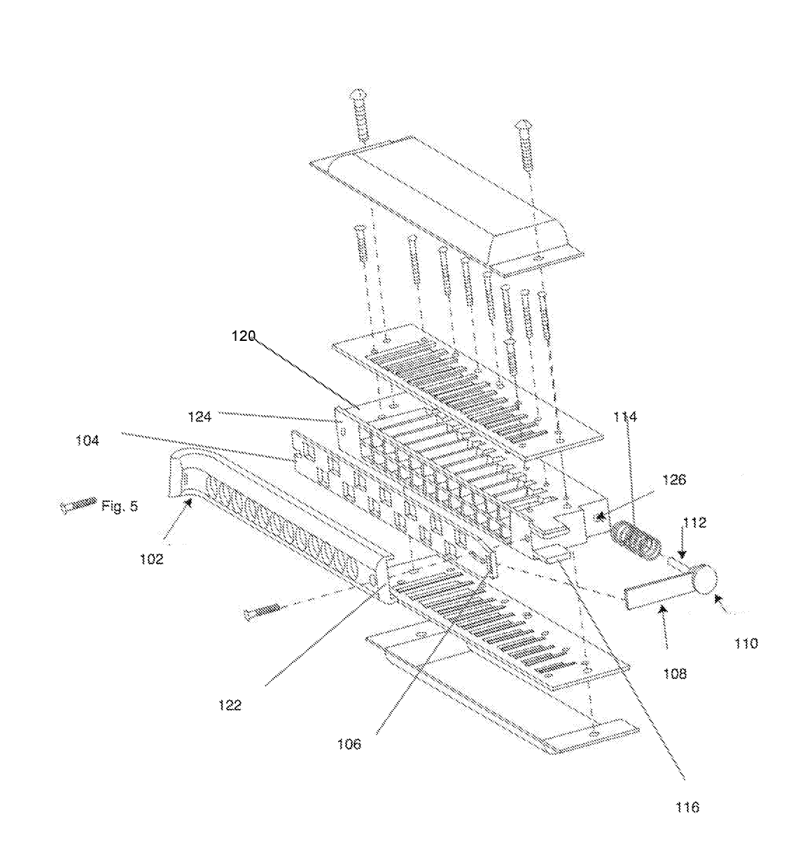

As shown in FIG. 5, a flexible mouthpiece 102 allows the inner face 122 of the mouthpiece 102 to rest directly on the low-friction valve slide 104 so that pressure from the player's mouth creates an airtight seal between the mouthpiece 102, valve slide 104, and the face 124 of the comb body 120.

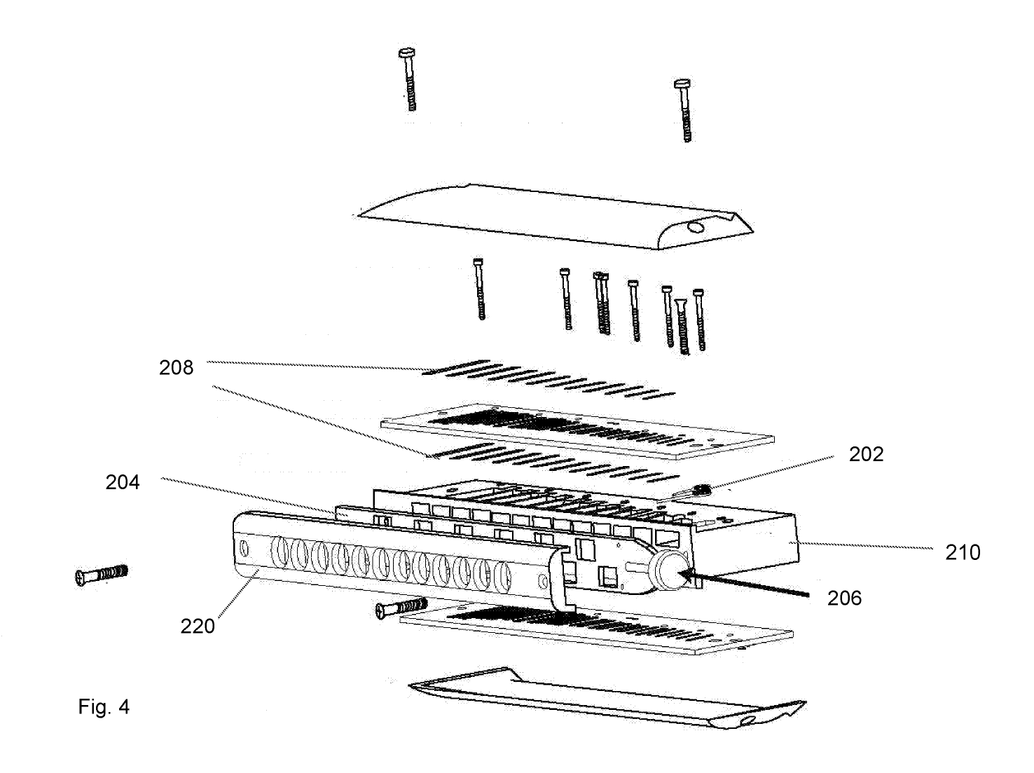

FIGS. 2 and 4 show a first type of conventional Chromatic Harmonica 200, which uses a torsion spring 202 disposed in the comb body 210 attached to a valve slide 204 which facilitates movement of the valve slide 204 back to its original position after the button 206 is pushed by a player. This torsion spring 202 and button 206 configuration would not function with a flexible mouthpiece 102, because, unlike the conventional mouthpiece 220 of FIG. 2 which uses a rigid mouthpiece, a flexible mouthpiece 102 would not prevent the torsion spring 202 from pushing the valve slide 104, 204 away from the comb body 120.

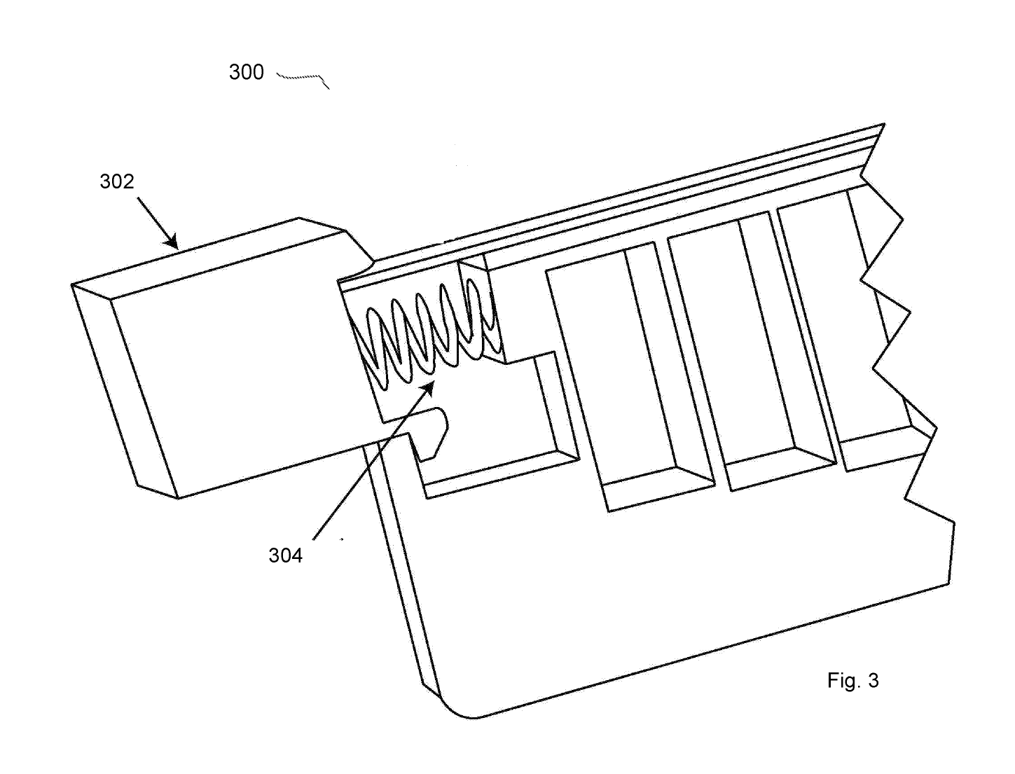

FIG. 3 shows a second type of conventional Chromatic Harmonica 300 which uses a button 302 and compression spring 304 configuration. A flexible mouthpiece (not shown) would not function with this second type of conventional Chromatic Harmonica because the button 302 would rock when pushed absent a rigid mouthpiece (not shown) to keep the compression spring 304 stable.

For a flexible mouthpiece to function on a Chromatic Harmonica, the button and spring configuration must be re-configured so that the spring does not push the valve slide away from the comb body, or does not rock when the button is pressed.

FIGS. 1 and 5 show a low-friction valve slide 104 comprising an opening 106 for insertion of a bar 108. The bar 108 is held stable with the help of two columns 116. At the end of the bar 108 is a button 110, from which a cylinder 112 protrudes in the direction of the rear of the comb body, where it inserts into a hole 126 which should be at least 0.002″ larger than the circumference of the cylinder 112 and be able to accommodate the entire length of the cylinder 112. The hole 126 and the cylinder 112 keep the bar 108 level when the button 110 is pushed. The cylinder 112 is surrounded by a compression spring 114. When a player presses the button 110, the bar 108 attached to the button 110 correspondingly pushes the low friction valve slide 104 horizontally along the face 124 of the comb body without exerting pressure against the flexible mouthpiece 102. When the button 110 is depressed, the compression spring 114 pushes the button 110, and by way of the bar 108, the low friction valve slide 104, back to their original positions. In this way, a player can manipulate the movement of the valve slide 104 while playing without the spring rocking or pushing the valve slide 104 away from the comb body. With the button in the rear of the chromatic harmonica, it also becomes easier for players to cup their hands when playing. Most importantly, through this configuration, the gap 218 where air escapes is now eliminated and the windsavers 208 that compensate for this gap become superfluous. A player can now create an airtight seal when playing the Chromatic Harmonica simply by pushing his lips against the flexible mouthpiece.

As shown in FIGS. 4 and 5, the construction of the inventive Chromatic Harmonica is similar to that of the conventional Chromatic Harmonica in that both are constructed with the same comb body, with the exception that wind savers 208 and the torsion spring 202 are removed from the body of the inventive Chromatic Harmonica and a hole 126 is bored into a side of the comb body adjacent the rear. The rigid mouthpiece is replaced with a flexible one. The conventional valve slide is replaced with a valve slide 104 composed of a low-friction material, and an additional opening 106 is added to one side of the valve slide 104 through which a bar 108 is inserted. Two columns 116 are added to a side of the comb body that is the same side where the valve slide 104 and bar 108 are located. A button 110 is disposed at the end of the bar 108 that is opposite to where the bar 108 is inserted into the valve slide 104. From the button 110, a cylinder 112 protrudes, around which a spring 114 is placed. The cylinder 112 is inserted into the hole 126.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

1. A chromatic harmonica with reduced air leakage comprising the following:
a flexible mouthpiece,
a low friction valve slide,
a comb body with a hole in one side adjacent a rear of the comb body,
a bar,
a button attached to said bar, and
a cylinder protruding from the button, said cylinder surrounded by a spring,
wherein one end of said bar is inserted through an opening in the low friction valve slide and the other end of said bar is disposed the button, and
wherein said cylinder protruding from said button is inserted in the hole of said comb body.

2. The chromatic harmonica of claim 1, wherein the flexible mouthpiece is composed of rubber.

3. The chromatic harmonica of claim 1, wherein the low friction valve slide is composed of Polyterafluoroethylene (PTFE), Polyoxymethylene (POM), or a PTFE-filled Acetal homopolymer.

4. The chromatic harmonica of claim 1, wherein the comb body further comprises two columns to help stabilize the bar.

5. The chromatic harmonica of claim 1, wherein the hole is at least 0.002″ larger than the circumference of the cylinder and the depth is deep enough to accommodate the length of the cylinder.

6. A method of assembling the chromatic harmonica of claim 1:
removing windsavers and a spring from a comb body of a chromatic harmonica;
creating a hole in one side of the comb body, adjacent the rear of the comb body;
disposing a flexible mouthpiece over a low friction valve slide,
screwing said flexible mouthpiece and low friction valve slide onto the face of the comb body;
inserting one end of a bar into an opening of the low friction valve slide, and disposing a button onto the other end of the bar, from which a cylinder protrudes;
placing a spring over the cylinder; and
inserting the cylinder inside of said hole of the comb body.

7. The method of claim 6, further comprising the step of inserting columns onto the same side of the comb body on which the hole is disposed to help stabilize movement of the bar horizontally.
